(19) United States
(12) Patent Application Publication
(10) Pub. No.: US 2016/0006332 A1
(43) Pub. Date: Jan. 7, 2016

(54) RECIPROCATING DEVICE FOR ELECTRIC HAIR CUTTER

(71) Applicant: Yen-Fu Liao, New Taipei (TW)

(72) Inventor: Yen-Fu Liao, New Taipei (TW)

(21) Appl. No.: 14/325,326

(22) Filed: Jul. 7, 2014

(51) Int. Cl. H02K 35/02

(52) U.S. Cl. CPC H02K 35/02

(57) ABSTRACT

A reciprocating device used for electric hair cutter includes a housing, a magnetism transmitting unit, a coil unit, a reciprocating unit, a pivotal unit and a stationary magnet unit. After the coil unit is fitted to the magnetism transmitting unit, the former is partially surrounded by the latter. Through the pivotal unit, the reciprocating unit is pivotally fitted to the reciprocating device near the latter's rear or front end. The front or rear portion of the reciprocating unit passes through the magnetism transmitting unit. The other end of the reciprocating unit passes through the stationary magnet unit. In this manner, a portion of the reciprocating unit is housed or enclosed in the magnetism transmitting unit, allowing a reduction in the size of the prior art reciprocating device and hence the electric hair cutter in the prior art.

### BACKGROUND OF THE INVENTION

1. Field of the Invention

The invention generally relates to an electric hair cutter. More particularly, the invention relates to a reciprocating device used for an electric hair cutter.

2. Description of the Prior Art

FIG. 1 is a top view of a prior art electric hair cutter (Taiwan Patent No. M369,233, with the title of “Improved Reciprocating Cutting Unit for Electric Hair Cutter”). In the electric hair cutter 70, hair is cut by the relative lateral motion of a mobile cutting unit 71 and a fixed cutting unit (not shown). The mobile cutting unit 71 is fitted to a connective unit 73, which is fixed down by a yoke-shaped flat piece 74 and two screws 75. The connective unit 73 is connected with a reciprocating unit 76 and a magnet 761 (with the N-pole pointing in one direction and the S-pole pointing in the opposite direction) is provided on a lower portion of the reciprocating unit 76. In use, after a motor 77 is turned on, an electromagnet 771 is magnetized and thus the reciprocating unit 76 may move laterally in a reciprocating manner due to the interaction between the magnet 761 and the electromagnet 771. When the motor 77 is turned off, two springs 78 pushes the reciprocating unit 76 back to its original central position.

Because the reciprocating unit 76 is disposed completely outside of the motor 77, the size of the electric hair cutter 70 has to depend on the length of the reciprocating unit 76. This factor makes it difficult to reduce the size of the electric hair cutter 70 and thus renders the hair cutter 70 inconvenient to carry.

### SUMMARY OF THE INVENTION

To eliminate the disadvantages of electric hair cutters in the prior art, the inventor has put in a lot of effort in the subject and has successfully come up with the reciprocating device of the present invention.

The reciprocating device of the present invention comprises a housing, a magnetism transmitting unit, a coil unit, a reciprocating unit, a pivotal unit and a stationary magnet unit. After the coil unit is fitted to the magnetism transmitting unit, the former is partially surrounded by the latter, which is disposed inside the housing. In use, the reciprocating unit is magnetized by the coil unit and the magnetism transmitting unit and may move laterally in a reciprocating manner due to its interaction with two magnets of the stationary magnet unit, which is disposed next to and faces the coil unit. Because the reciprocating unit passes through the magnetism transmitting unit and only a part of the former is outside of the latter, the size of an electric hair cutter may be substantially reduced.

The front end of the reciprocating unit passes through the magnetism transmitting unit and sticks out of the stationary magnet unit. The rear end of the reciprocating unit is pivotally fitted to the magnetism transmitting unit through the pivotal unit. In this manner, its front end is free to move laterally in a reciprocating manner outside of the stationary magnet unit. In a second embodiment, the pivotal point of the reciprocating unit is located near the midpoint of the reciprocating unit. In other words, the reciprocating unit is pivotally fitted to the magnetism transmitting unit near its midpoint. Its rear end passes through the magnetism transmitting unit and then the stationary magnet unit. Its front end sticks out of the magnetism transmitting unit. In this manner, its front end is free to move laterally in a reciprocating manner outside of the magnetism transmitting unit.

Two or four springs may be provided between the stationary magnet unit and the housing. After the electric hair cutter is turned on, these springs continue to push the reciprocating unit back to the central position. After the electric hair cutter is turned off, these springs keep the reciprocating unit at the central position.

In contrast to the reciprocating device of the electric hair cutter in the prior art, the reciprocating device of the present invention has at least the following two advantages:
(1) In the reciprocating device of the present invention, a portion of the reciprocating unit is housed or enclosed in the magnetism transmitting unit, allowing a reduction in the size compared to the prior art design and hence the electric hair cutter in the prior art.
(2) In use, the front end of the reciprocating unit is free to move laterally in a reciprocating manner outside of the stationary magnet unit (as in the first embodiment) or the magnetism transmitting unit (as in the second embodiment). Also, in use, this front end is connected with a cutter.

### BRIEF DESCRIPTION OF THE DRAWINGS

FIG. 1 is a top view of an electric hair cutter in the prior art.

FIG. 2 is a perspective view of a first embodiment of the reciprocating device of the present invention in an assembled condition.

FIG. 3 is an exploded view of the first embodiment.

FIG. 4 is an exploded view of a second embodiment of the reciprocating device of the present invention.

FIG. 5 is a perspective view of the second embodiment of the reciprocating device of the present invention in an assembled condition.

FIG. 6 is a top view showing the reciprocating motion of the second embodiment.

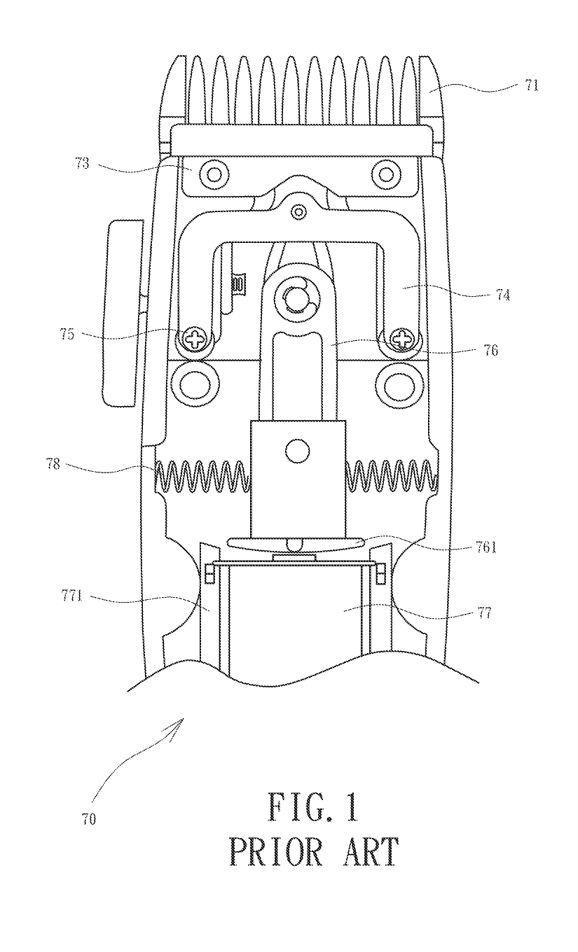

### DETAILED DESCRIPTION OF THE PREFERRED EMBODIMENTS

The purposes and advantages of the reciprocating device of the present invention will become more apparent and understandable when the following description is read in view of the accompanying drawings. Although two preferred embodiments of the present invention will be described in detail in the following, it should be understood that these preferred embodiments are to be regarded in an illustrative manner rather than a restrictive manner.

### First Embodiment

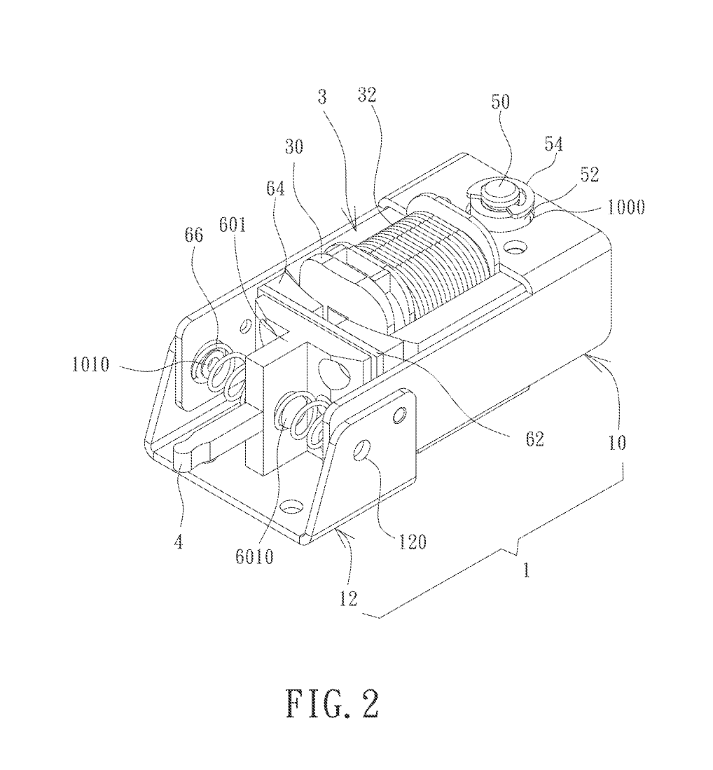

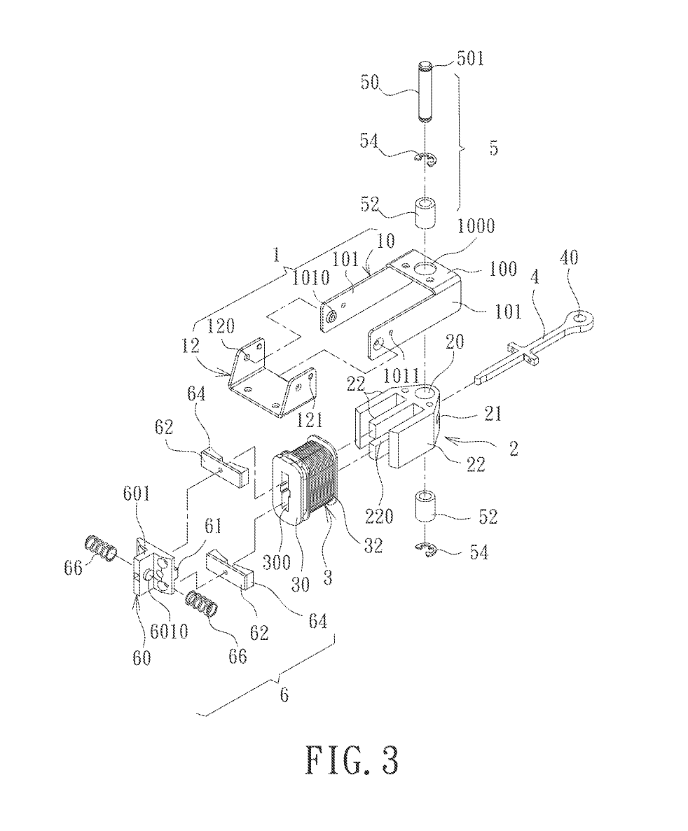

First, please see FIGS. 2 and 3. The reciprocating device of the present invention comprises a housing 1, a magnetism transmitting unit 2, a coil unit 3, a reciprocating unit 4, a pivotal unit 5 and a stationary magnet unit 6. The magnetism transmitting unit 2 is disposed inside the housing 1. The coil unit 3 may be fitted to the magnetism transmitting unit 2. The front end of the reciprocating unit 4 passes through a middle portion of the magnetism transmitting unit 2. The pivotal unit 5 passes through the housing 1, the magnetism transmitting unit 2 and the reciprocating unit 4 and is thus fitted to the magnetism transmitting unit 2 near the rear end of the magnetism transmitting unit 2. The stationary magnet unit 6 is disposed near the front end of the housing 1. The front end of the reciprocating unit 4 passes through the stationary magnet unit 6. In use, after the reciprocating device is powered up, the reciprocating unit 4 is magnetized by the coil unit 3 and the magnetism transmitting unit 2 and may move laterally in a reciprocating manner due to its interaction with the two (or two sets of) magnets 64.

The housing 1 comprises a first casing unit 10 and a second casing unit 12. The first casing unit 10 comprises a lateral piece 100 and two wall pieces 101. The lateral piece 100 connects the two wall pieces 101 at the rear side. A first hole 1000 is centrally provided in the lateral piece 100. A first protruding member 1010 is disposed on the front end of each wall piece 101. A first engagement design 1011 is provided in each wall piece 101 (between the corresponding protruding member 1010 and the lateral piece 100). The second casing unit 12 has a U shape with two walls and is connected with the front end of the first casing unit 10. A hole 120 and a second engagement design 121 are provided in each of the two walls of the second casing unit 12. Each hole 120 is engaged with the corresponding protruding member 1010 and each second engagement design 121 is engaged with the corresponding first engagement design 1011, so that the second casing unit 12 is fitted to the first casing unit 10.

The magnetism transmitting unit 2 may be made of silicon steel, but not limited thereto. A vertical through hole 20 is provided near the rear end of the magnetism transmitting unit 2 and a first horizontal through hole 21 is horizontally formed near the rear end of the magnetism transmitting unit 2. The magnetism transmitting unit 2 has three elongated legs 22 and has an “E” shape if viewed from the top. Slots 220 are formed in between these three legs 22 and are in communication with the first horizontal through hole 21.

The coil unit 3 comprises a core portion 30 and a coil portion 32. A through central bore 300 is provided in the core portion 30, so that the coil unit 3 may be fitted to the magnetism transmitting unit 2 when the central leg 22 of the magnetism transmitting unit 2 engages with the through central bore 300. The coil portion 32 wraps around the core portion 30. When current is fed to and through the coil unit 3, a north pole and a south pole will be generated on the two longitudinal ends of the coil unit 3.

The reciprocating unit 4 has a cross shape. The front end of the reciprocating unit 4 passes through the first horizontal through hole 21, the slots 220 and the through central bore 300. A second through hole 40 is provided near the rear end of the reciprocating unit 4. The pivotal unit 5 comprises a pivotal portion 50 and at least one bearing 52. The at least one bearing 52 is disposed inside the vertical through hole 20. The pivotal portion 50 is cylindrical and passes through the at least one bearing 52, then passes through the second through hole 40. Therefore, the two ends of the pivotal portion 50 stick out of the vertical through hole 20. Whence, the reciprocating unit 4 may move laterally and pivotally inside the magnetism transmitting unit 2. The pivotal unit 5 further includes two C-shaped rings 54. A slot 501 is provided near each end of the pivotal portion 50. After the two C-shaped rings 54 are fitted to the slots 501, the pivotal portion 50 may be retained inside the vertical through hole 20.

The stationary magnet unit 6 comprises a seat unit 60, two magnet retaining members 62, a plurality of magnets 64 and a plurality of springs 66. The seat unit 60 is disposed between the two protruding members 1010 of the first casing unit 10. A central member 601 is formed at the front end of the seat unit 60. A protruding member 61 is formed on the rear side of the seat unit 60. An opening 610 is centrally provided in the protruding member 61. The front end of the reciprocating unit 4 passes through the through central bore 300 of the coil unit 3 and the opening 610 to stick out of the seat unit 60. The two magnet retaining members 62 are disposed on the protruding member 61 of the seat unit 60 and two (or two sets of) magnets 64 are disposed on each of the two magnet retaining members 62. A second protruding member 6010 is formed on each of two sides of the central member 601. Each spring 66 is held between either of the first protruding members 1010 and the corresponding second protruding member 6010.

Because the two first protruding members 1010 and the two second protruding members 6010 protrudes outwards, each spring 66 may be held in between either of the first protruding members 1010 and the corresponding second protruding member 6010 and hence would not be displaced when the reciprocating unit 4 moves laterally.

In use, the reciprocating unit 4 is magnetized by the coil unit 3 and the magnetism transmitting unit 2 and may move laterally in a reciprocating manner due to its interaction with the magnets 64. Also, the magnetromotive force would increase and the reciprocating unit 4 would move more quickly if the number of windings of the coil portion 32 increases or if more current is fed. Moreover, the frequency of such lateral motion may be adjusted by adjusting the magnitude of the input currency. With a cutting unit connected to the reciprocating unit 4, an electric hair cutter may be formed for cutting hair.

### Second Embodiment

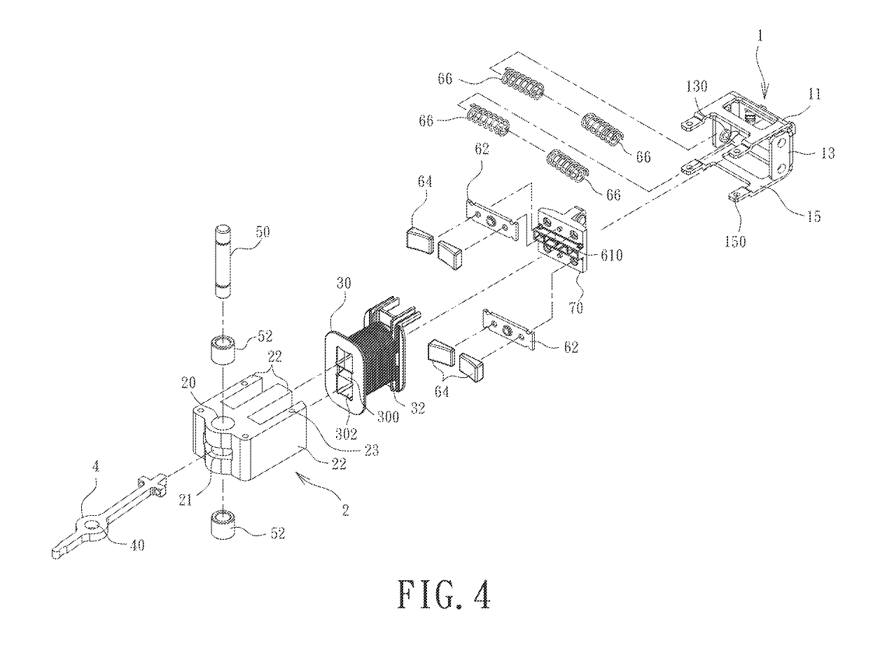

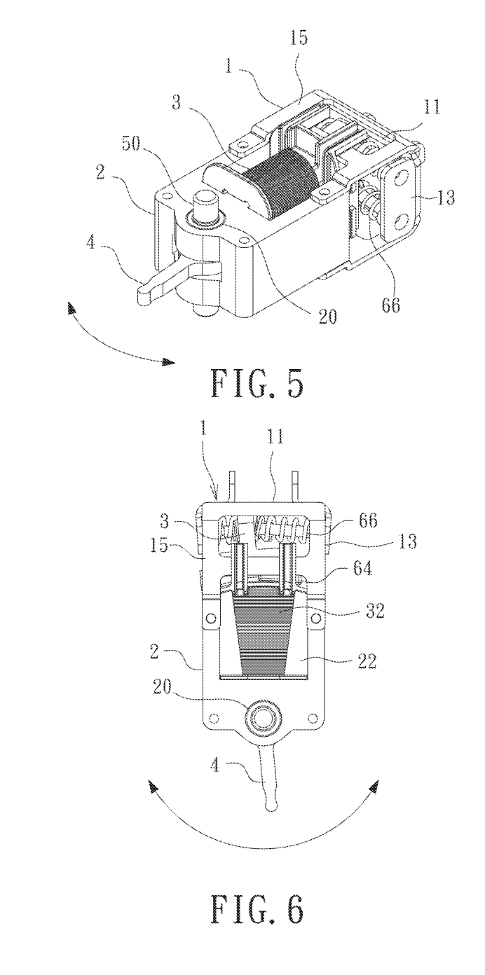

A second embodiment of the present invention is illustrated in FIGS. 4 to 6. The second embodiment is similar to the first embodiment, which has been previously described. The second embodiment and the differences between the first and second embodiments will be elaborated in the following. In the second embodiment, a housing 1 comprises a base piece 11, two spring retaining pieces 13 and two connective pieces 15. Each spring retaining piece 13 extends from the base piece 11 towards the front end of the housing 1. Two first protruding members 130 are formed on the front side of each spring retaining piece 13. Similarly, a second protruding member 6010 is formed on each side of the central member 601. Because the two first protruding members 130 and the two second protruding members 6010 protrude outwards, each spring 66 may be held in between either of the first protruding member 130 and the corresponding second protruding member 6010 and hence would not be displaced when the reciprocating unit 4 moves laterally.

Each of the two connective pieces 15 extends from the base piece 11 towards the front end of the housing 1. Two first connective holes 150 are provided in each of the two connective pieces 15. Four second connective holes 23 are provided on the magnetism transmitting unit 2. Therefore, screws or rivets may be used to fixedly attach the magnetism transmitting unit 2 to the housing 1 through these connective holes 150 and 23.

The coil unit 3 comprises a core portion 30 and a coil portion 32. A through central bore 300 is provided in the core portion 30, so that the coil unit 3 may be fitted to the magnetism transmitting unit 2 when the central leg 22 engages with the through central bore 300. An opening 302 is formed on either end of the through central bore 300. The coil portion 32 wraps around the core portion 30. When current is fed to and through the coil unit 3, a north pole and a south pole will be generated on the two sides of the coil unit 3. The reciprocating unit 4 has a cross shape. The front end of the reciprocating unit 4 passes through the first horizontal through hole 21, the slots 220 and the opening 302 to reach the protruding member 61. A second through hole 40 is provided near the midpoint of the reciprocating unit 4. The front end of the reciprocating unit 4 sticks out of the magnetism transmitting unit 2.

In use, the reciprocating unit 4 is magnetized by the coil unit 3 and the magnetism transmitting unit 2 and may move laterally in a reciprocating manner due to its interaction with the magnets 64.

In the first embodiment, two springs 66 are used; the pivotal unit 5 passes through the second through hole 40 formed near the rear end of the reciprocating unit 4; the housing 1 comprises a first casing unit 10 and a second casing unit 12; the front end of the reciprocating unit 4 sticks out of the central member 601; the reciprocating unit 4 may move in a reciprocating manner laterally. In the second embodiment, four springs 66 are used; the pivotal unit 5 passes through the second through hole 40 formed near the midpoint of the reciprocating unit 4; the housing 1 comprises a base piece 11, two spring retaining pieces 13 and two connective pieces 15; the front end of the reciprocating unit 4 sticks out of the magnetism transmitting unit 2; the reciprocating unit 4 may move in a reciprocating manner laterally. In these two embodiments, the pivotal point is located either at the rear end or near the midpoint of the reciprocating unit 4; in either embodiment, a portion of the reciprocating unit 4 is housed or enclosed in the magnetism transmitting unit 2, allowing a substantial reduction of the size of the reciprocating unit and hence solving the oversize problem of the reciprocating unit encountered in the prior art.

Although two preferred embodiments of the present invention have been described in detail hereinabove, it should be understood that the preferred embodiments are to be regarded in an illustrative manner rather than a restrictive manner, and all variations and modifications of the basic inventive concepts herein taught still fall within the scope of the present invention.

Many changes and modifications in the above described embodiments of the invention can, of course, be carried out without departing from the scope thereof Accordingly, the invention is intended to be limited only by the scope of the appended claims.

What is claimed is:

1. A reciprocating device used for electric hair cutter, comprising:
a housing;
a magnetism transmitting unit, disposed inside the housing;
a coil unit, fitted to and partially surrounded by the magnetism transmitting unit;
a reciprocating unit, whose front end passes through the central portion of the magnetism transmitting unit;
a pivotal unit, passing through the housing, a rear portion of the magnetism transmitting unit and the reciprocating unit, so that the reciprocating unit may be pivotally fitted to the magnetism transmitting unit; and
a stationary magnet unit, disposed near the coil unit in the housing, wherein the front end of reciprocating unit passes through the stationary magnet unit,
characterized in that, in use, the reciprocating unit may be magnetized by the coil unit and magnetism transmitting unit and may move laterally in a reciprocating manner due to its interaction with the two magnets.

2. The reciprocating device as in claim 1, wherein the housing comprises a first casing unit and a second casing unit, and wherein the first casing unit comprises a lateral piece and two wall pieces, characterized in that a first hole is centrally provided in the lateral piece, and that the lateral piece links up the two wall pieces, a first protruding member is disposed on the front end of either wall piece and a first engagement design is provided on either wall piece (between the corresponding first protruding member and the lateral piece), and characterized in that the second casing unit has a U shape and is connected with the front end of the first casing unit, and that a hole and a second engagement design are provided in either wall of the second casing unit, and that either hole may engage with the corresponding protruding member and either second engagement design may engage with the corresponding first engagement design, so that the second casing unit may be fitted to the first casing unit.

3. The reciprocating device as in claim 2, wherein a vertical through hole is provided near the rear end of the magnetism transmitting unit and a first horizontal through hole is formed at the rear end of the magnetism transmitting unit, characterized in that the magnetism transmitting unit has three elongated legs and hence has an “E” shape if viewed from the top, and that slots are formed in between these three legs and these slots are in communication with the first horizontal through hole.

4. The reciprocating device as in claim 3, wherein the coil unit comprises a core portion and a coil portion and a through central bore is provided in the core portion, so that the coil unit may be fitted to the magnetism transmitting unit when the central leg engages with the bore, and wherein the coil portion wraps around the core portion.

5. The reciprocating device as in claim 4, wherein the reciprocating unit has a cross shape and the front end of the reciprocating unit passes through the first horizontal through hole, lots and opening, and wherein a second through hole is provided near the rear end of the reciprocating unit.

6. The reciprocating device as in claim 5, wherein the pivotal unit comprises a pivotal portion and at least a bearing, and wherein the bearings pass through the second through hole and are disposed inside the vertical through hole, and wherein the pivotal portion is cylindrical and passes through the bearings, and wherein the two ends of the pivotal portion stick out of the hole.

7. The reciprocating device as in claim 6, wherein the pivotal unit further includes two C-shaped rings and either C-shaped ring may be fitted to a slot provided near an end of the pivotal portion.

8. The reciprocating device as in claim 7, wherein the stationary magnet unit comprises a seat unit, two magnet retaining members, a plurality of magnets and a plurality of springs, characterized in that the seat unit is disposed between the two protruding members of the first casing unit and a central member is formed at the front end of the seat unit, and that a protruding member is formed on the rear side of the seat unit, and that an opening is centrally provided in the protruding member, and characterized in that the two magnet retaining members are disposed on the protruding member of the seat unit and two magnets are disposed on the two magnet retaining members, and that each spring is held between either first protruding member and the corresponding second protruding member, and that the front end of the reciprocating unit passes through the through central bore of the core unit and the opening of the protruding member to stick out of the seat unit.

9. The reciprocating device as in claim 8, wherein because the two first protruding members and the two second protruding members protrudes outwards, each spring may be held in between either first protruding member and the corresponding second protruding member and hence would not be displaced when the reciprocating unit moves laterally.

10. The reciprocating device as in claim 1, wherein the housing comprises a base piece, two spring retaining pieces and two connective pieces, and wherein each retaining piece longitudinally extends from the base piece towards the front end of the housing and the two connective pieces also longitudinally extends from the base piece towards the front end of the housing, characterized in that two first connective holes are provided in each connective piece and four second connective holes are provided in the magnetism transmitting unit, and that therefore, screws or rivets may be used to fixedly attach the magnetism transmitting unit to the housing through these connective holes.

11. The reciprocating device as in claim 10, wherein a through hole is provided near the rear end of the magnetism transmitting unit and a first horizontal hole is formed at the rear end of the magnetism transmitting unit, characterized in that the magnetism transmitting unit has three elongated legs and hence has an “E” shape if viewed from the top, and that slots are formed in between these three legs and these slots are in communication with the first horizontal through hole.

12. The reciprocating device as in claim 11, wherein the coil unit comprises a core portion and a coil portion, and wherein a through central bore is provided in the core portion and an opening is formed on either end of the through central bore, so that the coil unit may be fitted to the magnetism transmitting unit through the openings and the through central bore.

13. The reciprocating device as in claim 12, wherein the reciprocating unit has a cross shape and the front end of the reciprocating unit passes through the first through hole, slots and opening to reach the protruding member, and wherein a second through hole is provided near the midpoint of the reciprocating unit and the front end of the reciprocating unit sticks out of the magnetism transmitting unit.

14. The reciprocating device as in claim 13, wherein the pivotal unit comprises a pivotal portion and at least a bearing, and wherein the bearings pass through the second through hole and are disposed inside the vertical through hole, and wherein the pivotal portion is cylindrical and passes through the bearings, and wherein the two ends of the pivotal portion stick out of the hole.

15. The reciprocating device as in claim 14, wherein the pivotal unit further comprises two C-shaped rings and either C-shaped ring may be fitted to a slot provided near an end of the pivotal portion.

16. The reciprocating device as in claim 15, wherein the stationary magnet unit comprises a seat unit, two magnet retaining members, a plurality of magnets and a plurality of springs, characterized in that the seat unit is disposed between the two protruding members of the first casing unit and a central member is formed at the front end of the seat unit, and that a protruding member is formed on the rear side of the seat unit, and that an opening is centrally provided in the protruding member, and characterized in that the two magnet retaining members are disposed on the protruding member of the seat unit and two magnets are disposed on the two magnet retaining members, and that each spring is held between either first protruding member and the corresponding second protruding member, and that the rear end of the reciprocating unit passes through the through central bore of the core portion, so that the two shoulder segments of the reciprocating unit press against the protruding member.
